(19) United States
(12) Patent Application Publication
(10) Pub. No.: US 2020/0198961 A1
(43) Pub. Date: Jun. 25, 2020

(54) BAGGED SPRING BED CORE WITH SIDE CONNECTED TO STRIP-SHAPED MATERIAL AND MANUFACTURING DEVICE AND METHOD THEREOF

(71) Applicant: Guangzhou Lianrou Machinery & Equipment Co., Ltd., Guangzhou City, Guangdong (CN)

(72) Inventors: Zhiming Tan, Guangzhou City, Guangdong (CN); Jie Liang, Guangzhou City, Guangdong (CN)

(21) Appl. No.: 16/625,994

(22) PCT Filed: Feb. 22, 2019
(86) PCT No.: PCT/CN2019/075885

§ 371 Date: Dec. 23, 2019

(30) Foreign Application Priority Data
Aug. 31, 2018 (CN) 2018110218951

(51) Int. Cl. B68G 7/052; A47C 27/06; A47C 27/07

(52) U.S. Cl. CPC B68G 7/052; A47C 27/07; A47C 27/064

(57) ABSTRACT

Disclosed are a bagged spring bed core with a side connected to a strip-shaped material and a manufacturing device and method thereof. The bed core is formed by arranging and bonding bagged spring strings connected to a strip-shaped material. The device includes a string feeding mechanism, a feeding mechanism, a tidying mechanism, and a sealing and cutting mechanism. The sealing and cutting mechanism cuts off the bagged spring string and the strip-shaped material to form bagged springs connected to the strip-shaped material. By bonding the strip-shaped material, the bagged spring string is no longer easily elongated or shortened by the action of an external force, so that the finally formed bagged spring bed core has good dimensional stability and can be compressed and coiled for packaging. Moreover, the strip-shaped material is provided between adjacent bagged spring strings in the bed core, so that the bed core has better durability.

### FIELD

The disclosure relates to the technical field of production of bagged springs, and in particular to a bagged spring bed core with a side connected to a strip-shaped material and a manufacturing device and method thereof.

### BACKGROUND

A bagged spring is formed by respectively wrapping and packaging individual springs in a cloth bag, bagged springs are sequentially connected to form a bagged spring string, and the bagged spring strings are arranged and bonded together to form a bagged spring bed core. Since the bagged spring string is formed by sequentially connecting the bagged springs through a cloth in the longitudinal direction, the bagged spring string is easily displaced and deformed in the longitudinal direction, which makes the size of the bagged spring bed core unstable.

In order to overcome this technical problem, patent EP2653070A1 discloses a bagged spring bed core in which a rigid reinforcing strip 4 is bonded and fixed between adjacent bagged spring strings 1, and the rigid reinforcing strip 4 is made of plastic, wood, steel wires, or the like. By means of the rigid reinforcing strip 4, the movement of each cloth bag 2 of the bagged spring string 1 is restricted, so as to avoid the occurrence of displacement and deformation. Since the rigid reinforcing strip 4 needs to be fixed additionally, the cost is high and the production process is complicated. Moreover, the adhesion between the rigid reinforcing strip made of the plastic or wood and the strip-shaped material is poor, as a result, the formed bagged spring bed core has poor durability. In addition, the bagged spring bed core of this structural form cannot be coiled, and occupies a large space during storage and transportation.

### SUMMARY OF THE INVENTION

The technical problem to be solved by the disclosure is to provide a low-cost, stable and durable bagged spring bed core with a side connected to a strip-shaped material and a manufacturing device and method thereof.

A technical solution adopted for solving the foregoing technical problem is: a device for manufacturing a bagged spring bed core with a side connected to a strip-shaped material, including a string feeding mechanism for conveying a bagged spring string, a feeding mechanism for conveying a strip-shaped material, a tidying mechanism for superposing and connecting the bagged spring string to the strip-shaped material, and a sealing and cutting mechanism for cutting off the bagged spring string and the strip-shaped material between the string feeding mechanism and the tidying mechanism.

Preferably, before the bagged spring string is superposed to the strip-shaped material, glue is sprayed onto the strip-shaped material and/or the bagged spring string by means of a first glue-spraying component.

Preferably, the bagged spring string and the strip-shaped material are collectively cut off and subjected to solder sealing together by the sealing and cutting mechanism.

Preferably, the tidying mechanism includes a tidying impeller and a conveying belt which are arranged up and down at an interval, and a gap between the tidying impeller and the conveying belt through which the superposed bagged spring string and the strip-shaped material pass.

Preferably, the tidying mechanism further includes a magnetic suction device disposed at a bottom of the conveying belt.

Preferably, the string feeding mechanism includes a string feeding impeller and a reciprocating bracket which are arranged up and down at an interval.

Preferably, the sealing and cutting mechanism includes an ultrasonic die head moving up and down in an opening and closing mode, an ultrasonic welding knife and a cutting-off component for cutting off the strip-shaped material; each of the ultrasonic die head and the ultrasonic welding knife is correspondingly provided with a sliding groove at a closed contact portion, and the cutting-off component is disposed in the sliding groove and can move back and forth.

Preferably, the cutting-off component is an electric heating cutter.

Preferably, the device further includes a combination mechanism for bonding and combining bagged spring strings connected to a strip-shaped material to form a bagged spring bed core, and before the bagged spring bed core is formed by bonding and combining, glue is sprayed on the bagged spring strings connected to the strip-shaped material by means of a second glue-spraying component.

Preferably, the combination mechanism includes a support for fixing the bagged spring bed core and a reciprocating mechanism for pushing the bagged spring string connected to the strip-shaped material into the support.

Preferably, the reciprocating mechanism is formed by a conveying belt that can reciprocate up and down.

Preferably, a speed difference between the tidying impeller and the conveying belt is adjustable.

Preferably, a glue outlet of the first glue-spraying component is opposite to the strip-shaped material to spray glue on the strip-shaped material.

Preferably, the first glue-spraying component is disposed below the bracket; a notch is formed penetrating the bracket; and the glue outlet of the first glue-spraying component is opposite to the notch of the bracket to spray glue on the bagged spring string through the notch.

A technical solution adopted to solve the foregoing technical problems is: a method for manufacturing a bagged spring bed core with a side connected to a strip-shaped material, including: respectively providing a bagged spring string and a strip-shaped material; superposing and connecting the bagged spring string to the strip-shaped material, and cutting the bagged spring string connected to the strip-shaped material into a predetermined length; and forming a bagged spring bed core by bonding and combining a plurality of the bagged spring strings each connected to the strip-shaped material side by side, or by staggering and bonding a plurality of the bagged spring strings each connected to the strip-shaped material with common bagged spring strings.

Preferably, the method further includes: spraying glue on a position where the bagged spring string is in contact with the strip-shaped material, so as to bond the strip-shaped material to the bagged spring string; cutting the bagged spring string connected to the strip-shaped material into a predetermined length; and fixing two ends of the strip-shaped material at a head end and a tail end of the bagged spring string, respectively.

Preferably, the method further includes: adjusting, when the bagged spring string is bonded to the strip-shaped material, the bagged spring string so that individual springs of the bagged spring string are adjacent to each other, and stretching the strip-shaped material to make the strip-shaped material in a tightened state.

A technical solution adopted to solve the foregoing technical problems is: a bagged spring bed core with a side connected to a strip-shaped material, where the bagged spring bed core is formed by arranging and bonding bagged spring strings each connected to a strip-shaped material, the strip-shaped material is bonded to a side of the bagged spring string, and two ends of the strip-shaped material are fixed at a head end and a tail end of the bagged spring string, respectively.

Preferably, the bagged spring strings each connected to the strip-shaped material are bonded to common bagged spring strings.

Preferably, the bagged spring string connected to the strip-shaped material is bonded to a sponge strip or a latex strip.

Preferably, the head end and the tail end of the bagged spring string connected to the strip-shaped material are each provided with three layers of materials, where two layers are cloths of the bagged spring string, and another layer is a bonded strip-shaped material.

Preferably, a width of the strip-shaped material is equal to or smaller than a height of the bagged spring string.

Preferably, the strip-shaped material is a non-woven fabric, a mesh fabric or foamed cotton, and the bagged spring string is a single-layer bagged spring string, a double-layer bagged spring string or a multi-layer bagged spring string.

Beneficial effects: according to the bagged spring bed core with a side connected to a strip-shaped material and the manufacturing device and method thereof, by bonding the strip-shaped material, the bagged spring string is no longer easily elongated or shortened by the action of an external force, so that the finally formed bagged spring bed core has good dimensional stability and can be compressed and coiled for packaging, thereby overcoming the shortcomings that the fixation of a conventional frame or a rigid reinforcing strip makes the bagged spring bed core difficult to compress and coil for packaging. Moreover, the strip-shaped material is provided between adjacent bagged spring strings in the bed core, so that the bed core has better durability. According to the manufacturing device and method, the strip-shaped material can be efficiently and stably bonded to the side of the bagged spring string without additionally providing a complicated mechanism for bonding the strip-shaped material, the structure is simple, and the production is efficient.

### BRIEF DESCRIPTION OF THE DRAWINGS

The disclosure will be further described below in conjunction with accompanying drawings and embodiments.

FIG. 1 is a schematic structural diagram of a manufacturing device according to an embodiment of the disclosure;

FIG. 2 is a schematic structural diagram of a manufacturing device according to another embodiment of the disclosure;

FIG. 3 is a schematic structural diagram of a manufacturing device according to a further embodiment of the disclosure;

FIG. 4 is a schematic structural diagram of a first state of a manufacturing device according to an embodiment of the disclosure;

FIG. 5 is a schematic structural diagram of a second state of the manufacturing device according to the embodiment of the disclosure;

FIG. 6 is a schematic structural diagram of a third state of the manufacturing device according to the embodiment of the disclosure;

FIG. 7 is a schematic structural diagram of a fourth state of the manufacturing device according to the embodiment of the disclosure;

FIG. 8 is a schematic structural diagram of a fifth state of the manufacturing device according to the embodiment of the disclosure;

FIG. 9 is a schematic structural diagram of a sixth state of the manufacturing device according to the embodiment of the disclosure;

FIG. 10 is a schematic structural diagram of a bagged spring bed core according to an embodiment of the disclosure;

FIG. 11 is a top view of a bagged spring bed core according to an embodiment of the disclosure; and

FIG. 12 is a top view of a bagged spring bed core according to another embodiment of the disclosure.

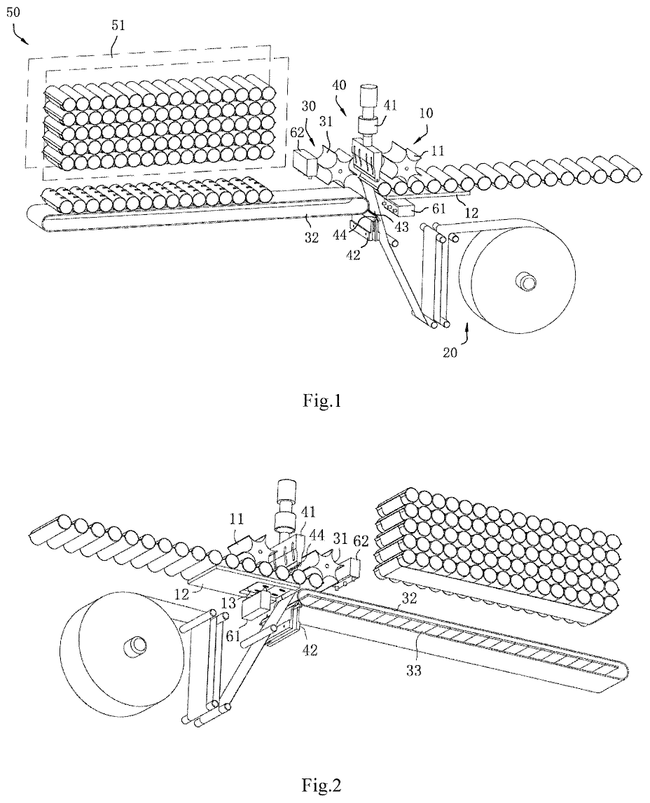

### DETAILED DESCRIPTION OF THE EMBODIMENTS

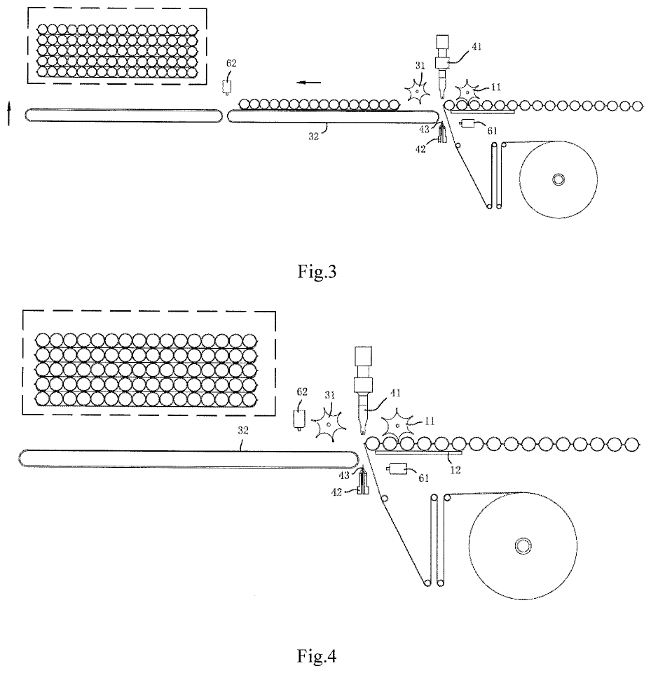

Referring to FIGS. 1 and 3, the disclosure provides a bagged spring bed core with a side connected to a strip-shaped material and a manufacturing device thereof including a string feeding mechanism 10, a feeding mechanism 20, a tidying mechanism 30, a sealing and cutting mechanism 40, and a combination mechanism 50. The string feeding mechanism 10 and the tidying mechanism 30 are disposed opposite to each other in a front-and-rear mode. The sealing and cutting mechanism 40 is disposed between the string feeding mechanism 10 and the tidying mechanism 30. The combination mechanism 50 is disposed behind the tidying mechanism 30. The feeding mechanism 20 is disposed below the string feeding mechanism 10.

The string feeding mechanism 10 is configured to convey a continuous bagged spring string into the tidying mechanism 30. Specifically, the string feeding mechanism 10 includes an upper string feeding impeller 11 and a lower bracket 12, and a gap through which the bagged spring string passes is formed between the string feeding impeller 11 and the bracket 12. Arc-shaped grooves corresponding to individual springs in the bagged spring string are formed on the surface of the string feeding impeller 11 in the circumferential direction. When the string feeding impeller 11 rotates, the string feeding impeller 11 pokes individual springs so that the bagged spring string moves forwards horizontally and is conveyed to the tidying mechanism 30. The bracket 12 is configured to reciprocate. When the bagged spring string is fed, the bracket 12 moves forwards to make up a gap at the position of the sealing and cutting mechanism 40, so that the bagged spring string can be smoothly driven into the tidying mechanism 30.

The feeding mechanism 20 is configured to continuously convey the strip-shaped material to a side of the bagged spring string for connection thereto, and the feeding mechanism 20 moves the strip-shaped material in a predetermined direction by means of a plurality of roller shafts, and makes the strip-shaped material conveyed in a tightened state. In this embodiment, the strip-shaped material is moved from bottom to top and conveyed to the side of the bagged spring string, and when the strip-shaped material enters the tidying mechanism 30, the strip-shaped material turns to be parallel to the bagged spring string.

The tidying mechanism 30 is configured to superpose and connect the bagged spring string to the strip-shaped material. The tidying mechanism 30 includes an upper tidying impeller 31 and a lower conveying belt 32, and a gap through which the bagged spring string passes is formed between the tidying impeller 31 and the conveying belt 32. Similarly, arc-shaped grooves are formed on the surface of the tidying impeller 31 in the circumferential direction. When the bagged spring string moves to the tidying mechanism 30, the tidying impeller 31 rotates, individual springs are poked by the arc-shaped grooves of the tidying impeller 31 to move the bagged spring string. Meanwhile, the conveying belt 32 operates to drive the bagged spring string to move. By adjusting and changing a speed difference between the tidying impeller 31 and the conveying belt 32, the pitch between adjacent individual springs in the bagged spring string can be adjusted to tidy the bagged spring string. For example, the speed of the tidying impeller 31 may be greater than that of the conveying belt 32, so that adjacent individual springs in the bagged spring string are conveyed forwards in a state of being next to each other; that is, the bagged spring string is compressed in the length direction, so that the finally formed bagged spring string connected to the strip-shaped material is no longer easily lengthened or shortened by the action of an external force, and the dimensional stability is good.

A magnetic suction device 33 may further be disposed at the bottom of the conveying belt 32. The magnetic suction device 33 may be a magnet, an attractive force is generated on springs in the bagged spring string across the conveying belt 32, thereby avoiding the situation that the bagged spring string slips or arches on the surface of the conveying belt 32 when tidied and compressed or conveyed, so that the bagged spring string can be better transported against the conveying belt 32.

When the strip-shaped material is selected as a non-woven fabric or foamed cotton, it is necessary to spray glue on the surface of the strip-shaped material or the bagged spring string before the bagged spring string and the strip-shaped material enter the tidying mechanism. In this way, the bagged spring string and the strip-shaped material are in a superposed state and can be bonded together through glue. In this embodiment, a first glue-spraying component 61 is disposed below the bracket 12, and a glue outlet of the first glue-spraying component 61 faces towards the horizontal direction. Since the strip-shaped material is moved and conveyed from bottom to top, before the strip-shaped material turns, glue is sprayed on the surface of the strip-shaped material by means of the glue outlet. After the strip-shaped material turns to be parallel to the bagged spring string, that is, the strip-shaped material is in a superposed state, the strip-shaped material is naturally bonded to the side of the bagged spring string.

Certainly, the position where the glue is sprayed may also be on the bagged spring string; in this case, the glue outlet of the first glue-spraying component 61 is turned to be in the vertical direction, and the bracket 12 is penetrated to form a notch 13 at a position corresponding to the first glue-spraying component 61, and the first glue-spraying component 61 sprays the glue on the side of the bagged spring string through the formed notch 13. In this way, after the strip-shaped material turns to be parallel to the bagged spring string, that is, the strip-shaped material is in a superposed state, the strip-shaped material is naturally bonded to the side of the bagged spring string. Similarly, it is also possible to spray glue on two positions of both the strip-shaped material and the bagged spring string.

The specific mounting position of the first glue-spraying component 61 can be flexibly selected according to actual conditions, as long as glue can be sprayed on the surface of the strip-shaped material and/or the bagged spring string before the superposed bagged spring string and the strip-shaped material enter the tidying mechanism 30.

The sealing and cutting mechanism 40 is configured to cut off the bagged spring string and the strip-shaped material to form bagged spring string connected to the strip-shaped material of a predetermined length. In this embodiment, the sealing and cutting mechanism 40 includes an ultrasonic die head 41 moving up and down in an opening and closing mode, an ultrasonic welding knife 42 and a cutting-off component 43 for cutting off the strip-shaped material. The ultrasonic die head 41 and the ultrasonic welding knife 42 are moved to close to weld a cloth between adjacent individual springs in the bagged spring string to the strip-shaped material. In this way, when the strip-shaped material is cut off by the cutting-off component 43, cut-off ports of the strip-shaped material are also naturally welded to the head end and the tail end of the bagged spring string, the head end and the tail end of the strip-shaped material on each bagged spring string of a predetermined length are welded to the head end and the tail end of the bagged spring string; that is, the strip-shaped material is bonded to the side of the bagged spring string through glue, and two ends of the strip-shaped material are fixed at two ends of the bagged spring string through welding.

The ultrasonic welding knife 42 is internally hollow. The cutting-off component 43 is a cutter that is disposed inside the ultrasonic welding knife 42. An end portion of the ultrasonic welding knife 42 is provided with a sliding groove 44 for the cutter to extend out. Similarly, an end portion of the ultrasonic die head 41 is also provided with a sliding groove 44 for the cutter to extend in. After the strip-shaped material is welded by the closing and opening movement of the ultrasonic die head 41 and the ultrasonic welding knife 42, the cutter reciprocates in the sliding groove 44 to cut off the strip-shaped material. Preferably, the cutter is an electric heating cutter, and is energized and heated to cut off the strip-shaped material by high temperature.

When the strip-shaped material is a mesh fabric, it is not necessary to spray glue on the surface of the strip-shaped material and/or the bagged spring string by means of the first glue-spraying component 61. When the strip-shaped material and the bagged spring string are cut off and subjected to solder sealing by means of the sealing and cutting mechanism 40, the head end and the tail end of the strip-shaped material are welded to the head end and the tail end of the bagged spring string.

The combination mechanism 50 bonds side by side the bagged spring strings, each of which is connected to the strip-shaped material and cut into a predetermined length, to form a bagged spring bed core, and before the side-by-side adjacent bagged spring strings are bonded, it is necessary to spray glue on the bagged spring string. In this embodiment, a second glue-spraying component 62 is disposed at the position of the tidying impeller 31 above the conveying belt 32. A glue outlet of the second glue-spraying component 62 is downward vertically. After the bagged spring strings connected to the strip-shaped material are tidied by the tidying mechanism 30, glue is sprayed on the other side of the bagged spring string by means of the second glue-spraying component 62, and the conveying belt 32 moves the bagged spring strings to the combination mechanism 50 for side-by-side bonding to form the bagged spring bed core.

The combination mechanism 50 includes supports 51 arranged up and down and a reciprocating mechanism that can reciprocate up and down. The conveying belt 32 conveys the bagged spring string having glue sprayed on the other side thereof to the reciprocating mechanism, and the reciprocating mechanism moves upwards to push the bagged spring string into the support 51, to be bonded to the bagged spring strings in the support 51 together.

Preferably, the conveying belt 32 is configured to reciprocate up and down. The conveying belt 32 in the tidying mechanism 30 can be used as a part of the reciprocating mechanism, and the conveying belt 32 moves upwards to push the bagged spring string into the support 51, to be bonded to the bagged spring strings in the support 51 together. Certainly, the reciprocating mechanism may be additionally provided with a conveying belt which is different from the conveying belt 32 in the tidying mechanism 30, but the conveying belts are connected in a front-and-rear mode, as shown in FIG. 3.

The specific mounting position and the glue-spraying form of the second glue-spraying component 62 can be flexibly selected by those skilled in the art according to actual conditions. When the strip-shaped material is bonded to a side of a bagged spring string, glue can be synchronously sprayed to the other side of the bagged spring string; or after the strip-shaped material is completely bonded to a side of a bagged spring string, glue is sprayed by means of the second glue-spraying component 62, for example, the second glue-spraying component 62 can be configured to reciprocate above the conveying belt 32, glue is directly sprayed on a semi-finished bagged spring bed core. When the reciprocating mechanism pushes the bagged spring string bonded with the strip-shaped material into the support 51, the bagged spring string bonded with the strip-shaped material is bonded to the semi-finished bagged spring bed core, and the operations are repeated to form a complete bagged spring bed core.

When the strip-shaped material is a mesh fabric, it is only necessary to spray glue on the side of the bagged spring string by means of the second glue-spraying component 62. Since glue can penetrate through the mesh fabric, it is naturally possible to bond the adjacent bagged spring strings, and the glue only needs to be sprayed once.

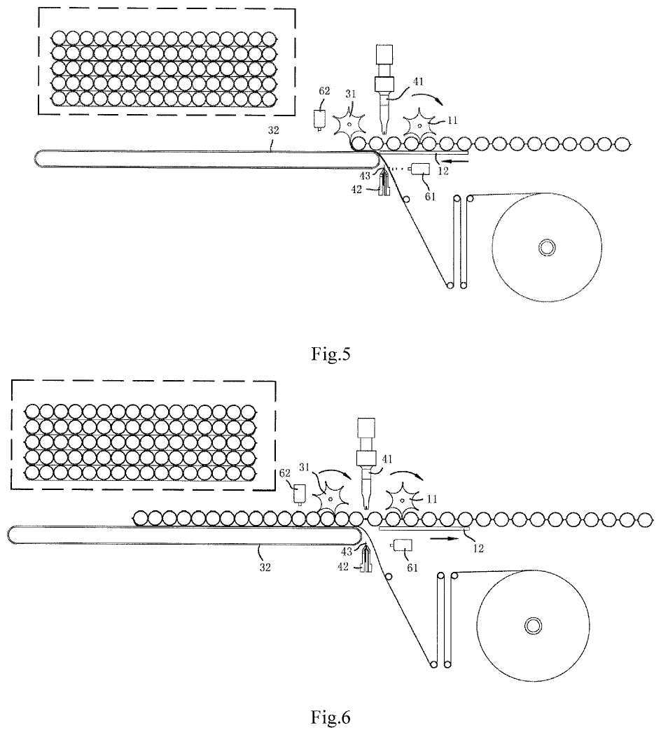

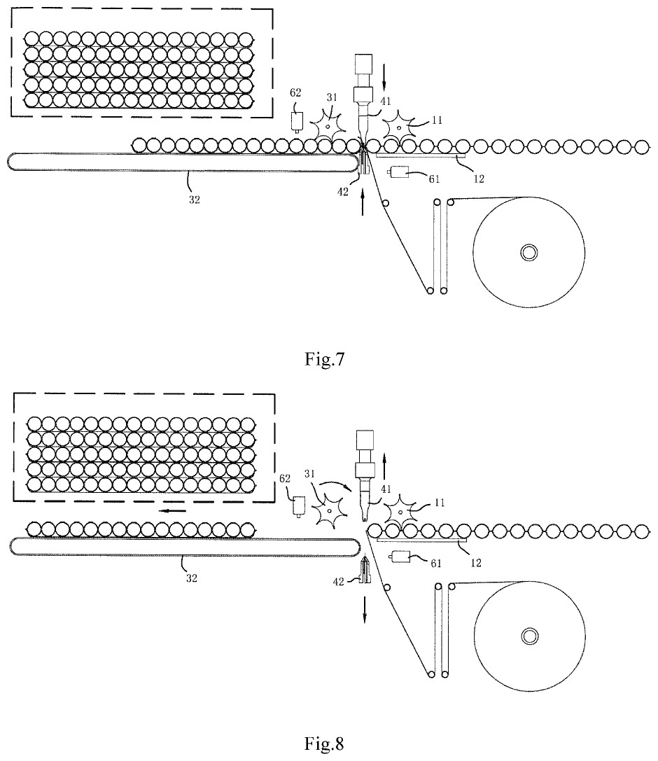

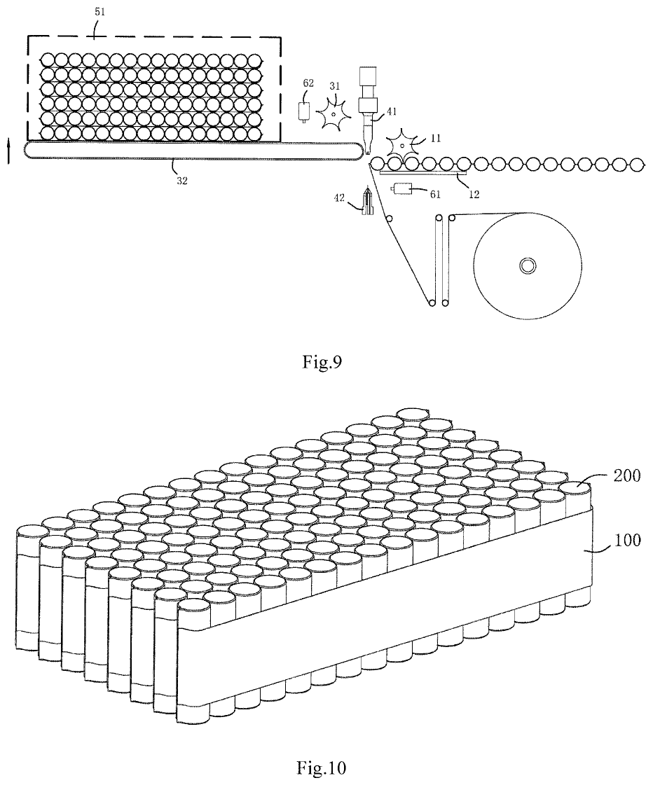

Referring to FIGS. 4-9, schematic diagrams showing that a bagged spring bed core with a side connected to a strip-shaped material is manufactured by the device for manufacturing a bagged spring bed core of the disclosure are illustrated. As shown in FIGS. 4 and 5, the string feeding impeller 11 of the string feeding mechanism 10 rotates to poke the bagged spring string to move forwards; meanwhile, the bracket 12 moves forwards to stride across the sealing and cutting mechanism 40 and moves to the conveying belt 32, the string feeding mechanism 10 and the feeding mechanism 20 act to respectively convey the bagged spring string and the strip-shaped material to the tidying mechanism 30; moreover, the first glue-spraying component 61 sprays glue on the strip-shaped material, and the strip-shaped material is bonded to the side of the bagged spring string by means of the glue. As shown in FIGS. 6 and 7, the tidying impeller 31 in the tidying mechanism 30 and the conveying belt 32 act to tidy and adjust the bagged spring string, so that individual springs in the bagged spring string are conveyed in a state of being next to each other; meanwhile, the second glue-spraying component 62 sprays the glue on the other side of the bagged spring string, the bracket 12 moves backwards to reset, the ultrasonic die head 41 and the ultrasonic welding knife 42 move in a closed mode to weld a cloth of the bagged spring string to the strip-shaped material, and the strip-shaped material is cut off by a cutter, so that the bagged spring string connected to the strip-shaped material of a predetermined length is formed. As shown in FIGS. 8 and 9, the ultrasonic die head 41 and the ultrasonic welding knife 42 open to reset, the tidying impeller 31 and the conveying belt 32 act to convey and move the cut-off bagged spring string connected to the strip-shaped material to the combination mechanism 50, the conveying belt 32 moves upwards to push the bagged spring string connected to the strip-shaped material into the support 51, to be bonded to the bagged spring strings in the support 51, thereby forming the bagged spring bed core.

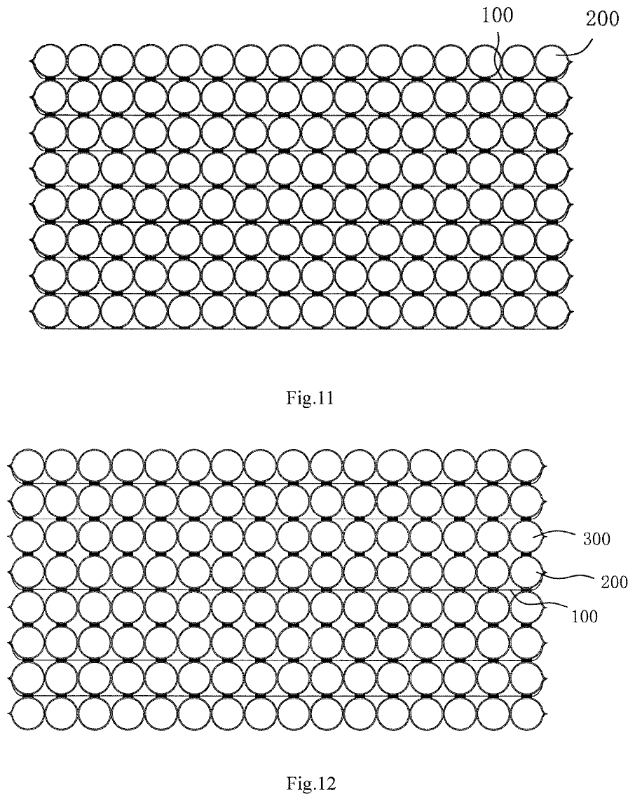

Referring to FIGS. 10 and 11, the bagged spring bed core with a side connected to a strip-shaped material provided by the disclosure is formed by arranging and bonding the bagged spring strings connected to the strip-shaped material, the strip-shaped material 100 is bonded to the side of the bagged spring string, and two ends of the strip-shaped material 100 are fixed at the head end and the tail end of the bagged spring string, respectively. The width of the strip-shaped material is equal to or smaller than the height of the bagged spring string. By bonding the strip-shaped material, the bagged spring string is no longer easily lengthened or shortened by the action of an external force, so that the finally formed bagged spring bed core has good dimensional stability. Moreover, since the strip-shaped material is provided between adjacent bagged spring strings, the cloth loss of the bagged spring string caused by friction between springs resulting from repeated squeezing of a mattress can be effectively reduced, so that the bed core has better durability.

Since the strip-shaped material and the bagged spring string are sealed and cut by ultrasonic waves, two ends of the strip-shaped material are also naturally welded to two ends of the bagged spring string, the head end and the tail end of the bagged spring string connected to the strip-shaped material are each provided with three layers of materials, where two layers are cloths of the bagged spring string, and another layer is a strip-shaped material.

Referring to FIG. 12, the bagged spring bed core is formed by staggering and bonding bagged spring strings 200 connected to the strip-shaped material and common bagged spring strings 300. The side of the common bagged spring string 300 is not bonded with the strip-shaped material, the amount of glue and strip-shaped material used is reduced, and it is also ensured that the bagged spring bed core has good dimensional stability. Certainly, a sponge strip or a latex strip may also be bonded between adjacent bagged spring strings 200 connected to the strip-shaped material.

Since adjacent bagged spring strings are bonded by means of glue to form a bed core, bonding glue points are certainly formed between the adjacent bagged spring strings. When the strip-shaped material 100 has a large width, the bonding glue points are completely disposed in an area of the strip-shaped material. Certainly, when the strip-shaped material 100 has a small width, at least one of the bonding glue points is distributed in a cloth area on an upper layer of the bagged spring string, and at least one bonding glue point is distributed in a cloth area on a lower layer of the bagged spring string.

The strip-shaped material 100 may be selected from a non-woven fabric, a mesh fabric or foamed cotton and the like according to the actual situation.

According to the method for manufacturing a bagged spring bed core with a side connected to a strip-shaped material provided by the disclosure, bagged spring strings 200 and a strip-shaped material 100 are respectively provided; glue is sprayed at a position where the bagged spring string 200 is in contact with the strip-shaped material 100 so that the strip-shaped material 100 is bonded to the bagged spring string 200, and the bagged spring string connected to the strip-shaped material is sealed and cut by means of ultrasonic waves and cut into a predetermined length. Since sealing and cutting are performed by means of the ultrasonic waves, two ends of the strip-shaped material are also naturally welded to two ends of the bagged spring string, and then the bagged spring strings connected to the strip-shaped material having the predetermined length are bonded and combined side by side to form the bagged spring bed core. When the strip-shaped material 100 is a mesh fabric, two ends of the strip-shaped material are fixed to two ends of the bagged spring string by means of ultrasonic sealing and cutting, it is not necessary to spray glue between the strip-shaped material and the bagged spring string, and the glue only needs to be sprayed on the other side of the adjacent bagged spring string. Since the glue can penetrate through the mesh fabric, the adjacent bagged spring strings can naturally be bonded and combined together.

Preferably, when the bagged spring strings 200 are bonded to the strip-shaped material 100, the bagged spring strings 200 are tidied and adjusted and compressed in the length direction, so that individual springs are adjacent to each other. Moreover, the strip-shaped material 100 is stretched to make the strip-shaped material in a tightened state. In this way, after bonding, the bagged spring string is in a more stable state in the length direction and is prevented from being lengthened or shortened by an external force.

The embodiments of the disclosure are described in detail above with reference to the accompanying drawings, but the disclosure is not limited to the above-described embodiments, and various changes can be made without departing from the principle of the disclosure within the scope of the knowledge of those of ordinary skill in the art. For example, the aforementioned embodiments are arranged in a vertical direction, and certainly, the embodiment can also be implemented horizontally.

1. A device for manufacturing a bagged spring bed core with a side connected to a strip-shaped material, comprising:
a string feeding mechanism for conveying a bagged spring string,
a feeding mechanism for conveying a strip-shaped material,
a tidying mechanism for superposing and connecting the bagged spring string to the strip-shaped material; and
a sealing and cutting mechanism for cutting off the bagged spring string and the strip-shaped material disposed between the string feeding mechanism and the tidying mechanism.

2. The device for manufacturing a bagged spring bed core with a side connected to a strip-shaped material of claim 1, wherein before the bagged spring string is superposed to the strip-shaped material, glue is sprayed onto the strip-shaped material and/or the bagged spring string by means of a first glue-spraying component.

3. The device for manufacturing a bagged spring bed core with a side connected to a strip-shaped material of claim 1, wherein the bagged spring string and the strip-shaped material are collectively cut off and subjected to solder sealing together by the sealing and cutting mechanism.

4. The device for manufacturing a bagged spring bed core with a side connected to a strip-shaped material of claim 1, wherein the tidying mechanism comprises a tidying impeller and a conveying belt which are arranged up and down at an interval, and a gap between the tidying impeller and the conveying belt through which the superposed bagged spring string and the strip-shaped material pass.

5. The device for manufacturing a bagged spring bed core with a side connected to a strip-shaped material of claim 4, wherein the tidying mechanism further comprises a magnetic suction device disposed at a bottom of the conveying belt.

6. The device for manufacturing a bagged spring bed core with a side connected to a strip-shaped material of claim 1, wherein the string feeding mechanism comprises a string feeding impeller and a reciprocating bracket which are arranged up and down at an interval.

7. The device for manufacturing a bagged spring bed core with a side connected to a strip-shaped material of claim 1, wherein the sealing and cutting mechanism comprises an ultrasonic die head moving up and down in an opening and closing mode, an ultrasonic welding knife and a cutting-off component for cutting off the strip-shaped material; each of the ultrasonic die head and the ultrasonic welding knife is correspondingly provided with a sliding groove at a closed contact portion, and the cutting-off component is disposed in the sliding groove and can move back and forth.

8. The device for manufacturing a bagged spring bed core with a side connected to a strip-shaped material of claim 7, wherein the cutting-off component is an electric heating cutter.

9. The device for manufacturing a bagged spring bed core with a side connected to a strip-shaped material of claim 1, further comprising a combination mechanism for bonding and combining bagged spring strings connected to a strip-shaped material to form a bagged spring bed core, and before the bagged spring bed core is formed by bonding and combining, glue is sprayed on the bagged spring strings connected to the strip-shaped material by means of a second glue-spraying component.

10. The device for manufacturing a bagged spring bed core with a side connected to a strip-shaped material of claim 9, wherein the combination mechanism comprises a support for fixing the bagged spring bed core and a reciprocating mechanism for pushing the bagged spring string connected to the strip-shaped material into the support.

11. The device for manufacturing a bagged spring bed core with a side connected to a strip-shaped material of claim 10, wherein the reciprocating mechanism is formed by a conveying belt that can reciprocate up and down.

12. The device for manufacturing a bagged spring bed core with a side connected to a strip-shaped material of claim 4, wherein a speed difference between the tidying impeller and the conveying belt is adjustable.

13. The device for manufacturing a bagged spring bed core with a side connected to a strip-shaped material of claim 2, wherein a glue outlet of the first glue-spraying component is opposite to the strip-shaped material to spray glue on the strip-shaped material.

14. The device for manufacturing a bagged spring bed core with a side connected to a strip-shaped material of claim 6, wherein the first glue-spraying component is disposed below the bracket; a notch is formed penetrating the bracket; and the glue outlet of the first glue-spraying component is opposite to the notch of the bracket to spray glue on the bagged spring string through the notch.

15. A method for manufacturing a bagged spring bed core with a side connected to a strip-shaped material, comprising:
respectively providing a bagged spring string and a strip-shaped material;
superposing and connecting the bagged spring string to the strip-shaped material,
cutting the bagged spring string connected to the strip-shaped material into a predetermined length; and
forming a bagged spring bed core by bonding and combining a plurality of the bagged spring strings each connected to the strip-shaped material side by side, or by staggering and bonding a plurality of the bagged spring strings each connected to the strip-shaped material with common bagged spring strings.

16. The method for manufacturing a bagged spring bed core with a side connected to a strip-shaped material of claim 15, further comprising: spraying glue on a position where the bagged spring string is in contact with the strip-shaped material, so as to bond the strip-shaped material to the bagged spring string; cutting the bagged spring string connected to the strip-shaped material into a predetermined length; and fixing two ends of the strip-shaped material at a head end and a tail end of the bagged spring string, respectively.

17. The method for manufacturing a bagged spring bed core with a side connected to a strip-shaped material of claim 15, further comprising: adjusting, when the bagged spring string is bonded to the strip-shaped material, the bagged spring string so that individual springs of the bagged spring string are adjacent to each other, and stretching the strip-shaped material to make the strip-shaped material in a tightened state.

18. A bagged spring bed core with a side connected to a strip-shaped material, wherein the bagged spring bed core is formed by arranging and bonding bagged spring strings each connected to a strip-shaped material, the strip-shaped material is bonded to a side of the bagged spring string, and two ends of the strip-shaped material are fixed at a head end and a tail end of the bagged spring string, respectively.

19. The bagged spring bed core with a side connected to a strip-shaped material of claim 18, wherein the bagged spring strings each connected to the strip-shaped material are bonded to common bagged spring strings.

20. The bagged spring bed core with a side connected to a strip-shaped material of claim 18, wherein the bagged spring string connected to the strip-shaped material is bonded to a sponge strip or a latex strip.

21. The bagged spring bed core with a side connected to a strip-shaped material of claim 18, wherein the head end and the tail end of the bagged spring string connected to the strip-shaped material are each provided with three layers of materials, wherein two layers are cloths of the bagged spring string, and another layer is a bonded strip-shaped material.

22. The bagged spring bed core with a side connected to a strip-shaped material of claim 18, wherein a width of the strip-shaped material is equal to or smaller than a height of the bagged spring string.

23. The bagged spring bed core with a side connected to a strip-shaped material of claim 18, wherein the strip-shaped material is a non-woven fabric, a mesh fabric or foamed cotton, and the bagged spring string is a single-layer bagged spring string, a double-layer bagged spring string or a multi-layer bagged spring string.
